(19) United States
(12) Patent Application Publication
(10) Pub. No.: US 2008/0100708 A1
(43) Pub. Date: May 1, 2008

(54) System and Method for Obtaining Consumer Information

(76) Inventors: Timothy J. Coffey, Cincinnati, OH (US); Brian J. Watkins, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 11/925,171

(22) Filed: Oct. 26, 2007

Related U.S. Application Data
(60) Provisional application No. 60/813,624, filed on Oct. 30, 2006.

(51) Int. Cl. H04N 7/18

(52) U.S. Cl. 348/158; 348/E07.085; 348/E07.086; 348/E07.087; 348/E07.088; 348/E07.089; 348/E07.09

(57) ABSTRACT

A consumer research system and method integrates video and other forms of media recording or transmission to collect consumer information. Selected consumers are provided with instructions and video equipment. Instructions may be presented as video instructions or booklet instructions or a combination thereof. The instructions explain how the consumers should use the equipment and what information should be captured. Consumers may capture their activities and other information and submit the information as directed for further analysis.

### PRIORITY

This application claims priority to U.S. Provisional Application Ser. No. 60/813,624, entitled “System and Method for Obtaining Consumer Information,” filed Oct. 30, 2006, the disclosure of which is incorporated by reference herein.

### BACKGROUND

Some embodiments of the present invention relate to a system and method for obtaining consumer information. Some conventional systems and methods for obtaining and using consumer information may obtain and use consumer information in a variety of ways. While a variety of consumer research systems and methods have been developed and used, it is believed that no one prior to the inventor has developed or used a system or method as described in the appended claims.

### BRIEF DESCRIPTION OF THE FIGURES

FIG. 1 is a diagram showing an example flow of consumer information.

FIG. 2 is a diagram showing consumers capturing consumer information.

FIG. 3 is a diagram showing an example of instructional content.

FIG. 4 is a diagram showing a further example of the instructional content shown in FIG. 3.

FIG. 5 is a diagram showing a workflow example for conducting a consumer research study.

FIG. 6 is a diagram showing a workflow example for conducting a consumer research study.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the descriptions should be regarded as illustrative in nature and not restrictive.

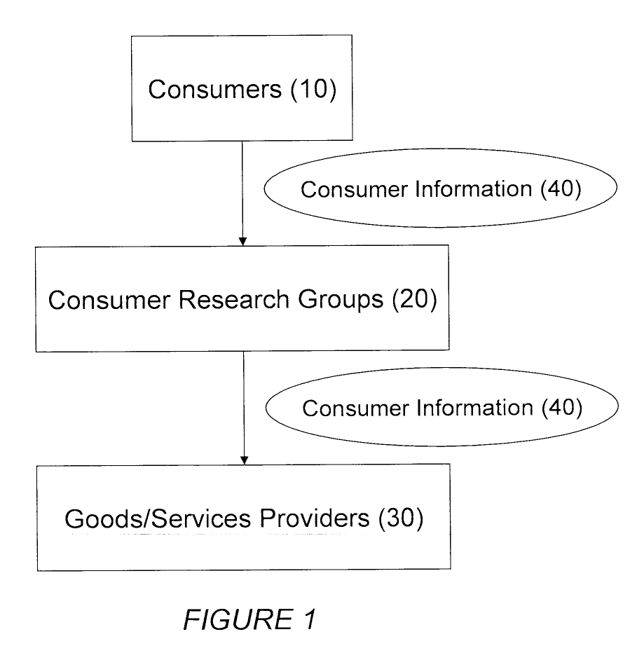

Embodiments of the present invention relate to a system and method for obtaining consumer information. As used herein, the term “consumer” is intended to include any person who consumes some form of product or service. While the term “consumer” is used herein in singular form, it should also be understood to include a plurality of consumers, such that the term “consumer” should be read interchangeably with the term “consumers.” “Consumer information” is intended to include information about consumers, including but not limited to biographic information, demographic information, information on consuming habits (e.g., consuming decisions, consumers' reasons for such choices, etc.), and environmental conditions in which consuming choices are made. Consumer information may be obtained in the context of a consumer's use of a good or service, outside the context of a consumer's use of a good or service, or in any other context. As shown in FIG. 1, it will be appreciated that the embodiments described herein may be used by entities such as consumer research groups 20 and the like to obtain consumer information 40 to provide to clients of such entities, such as producers or sellers of goods and/or services 30. Other suitable uses for the embodiments described herein, and entities for whom and by whom the embodiments may be used, will be apparent to those of ordinary skill in the art in view of the following teachings.

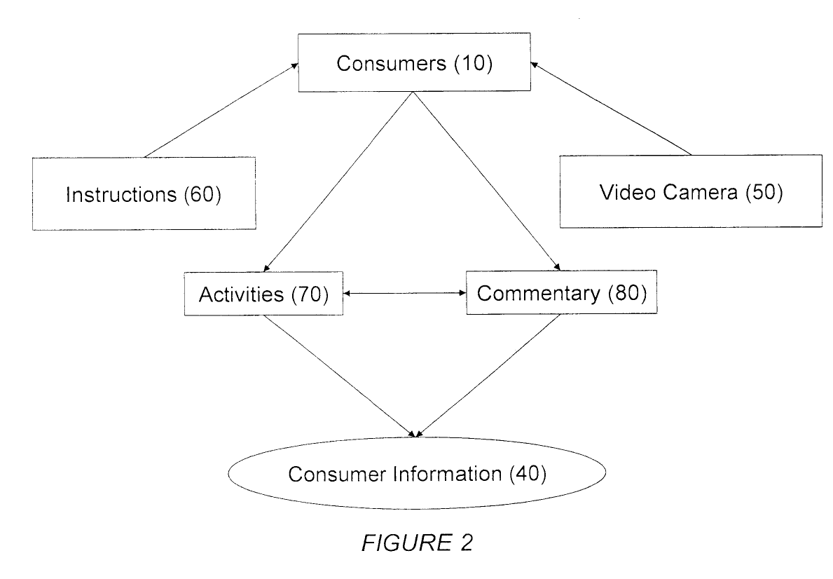

According to FIG. 2, in general terms, some embodiments include sending a video camera 50 to a consumer or group of consumers 10 (e.g., a family) with instructions 60 on how to use the video camera 50. The instructions 60 may instruct the consumers 10 to capture video of their activities 70, and to provide commentary 80 on the video while engaged in such activities 70. Each of these exemplary elements will be described in further detail below.

As noted above, embodiments include sending a video camera 50 to a consumer or group of consumers 10. In the example of FIG. 2, the video camera 50 is a VCAMNOW digital video camera by Hasbro, Inc. Alternatively, any other type of video camera 50 may be used, including but not limited to other types of digital video cameras, tape-based video cameras, film-based video cameras, or any other type. It will also be appreciated that the video camera 50 of the present example may be substituted or supplemented with any suitable device, including but not limited to a still image camera of any type, an audio recorder of any type, or any other device, including combinations thereof. Furthermore, while the present example includes the capture of video with the video camera 50, embodiments may also include the capture of still images, such as with the same video camera 50 used to capture the video, or with another device. In addition, while the present example includes the capture of audio occurring contemporaneous with the images and events in the video, embodiments may also include the capture of audio occurring before or after the images and events in the video, such as with the same video camera 50 used to capture the video, or with any other device. For instance, after a video or other image has been captured, a user may record “overdubs” or commentary 80 explaining what was happening or being thought at the time the video or other image was captured. Other ways in which information 40 may be obtained before, during, or after events will be apparent to those of ordinary skill in the art.

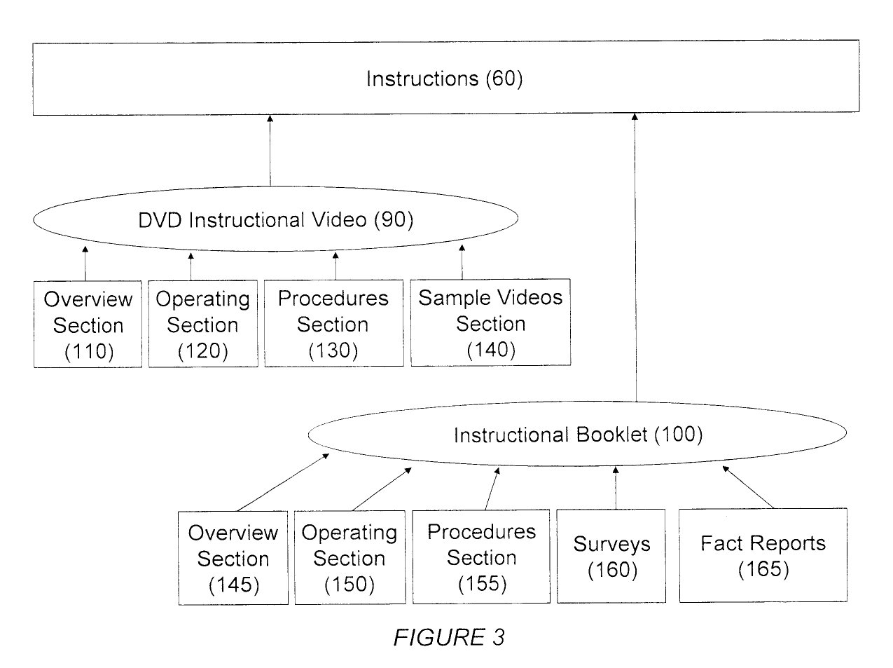

As noted above and in FIG. 2, embodiments include sending instructions 60 to a consumer or group of consumers 10 along with the video camera 50. The instructions 60 may be provided in any suitable form, including but not limited to written text, video, e-mails, web pages, or otherwise, including combinations of several forms. In the present example, as shown in FIG. 3, instructions 60 are sent in a DVD instruction video 90 and in a printed instructional booklet 100. The instructions 60 relate to how the consumer 10 is to use the video camera 50 of FIG. 2. As further shown in FIG. 2, the instructions 60 may instruct the consumer 10 to capture video of activities 70 the consumer 10 is engaged in, and to provide some form of commentary 80 relating to such activities 70. The instructions 60 may further prescribe certain activities 70 for the consumer 10 to engage in, and/or instruct the consumer 10 to simply capture video of day-to-day activities 70 the consumer 10 would otherwise engage in. The instructions 60 may further provide emphasis to the consumer 10 that the consumer 10 is to “act natural,” and to not change the way the consumer 10 would otherwise do things if the consumer 10 were not capturing video of his or her activities 70. With respect to commentary 80, the instructions 60 may instruct the consumer 10 to explain why they are engaged in activities 70 that they are engaged in, why they are engaging in an activity 70 in the particular way in which they are engaging in the activity 70, why they are making choices that are being captured on the video, or to provide other explanations. Of course, any other suitable components of a set of instructions 60 may be used.

As noted above, and as seen in FIG. 3, the set of instructions 60 in the present example comprises a DVD video 90. The consumer 10 may be given instructions 60, written or otherwise, to view the DVD video 90 before capturing video with the video camera 50. It will be appreciated that the instructional video 90 may comprise a variety of elements. For instance, the instructional video 90 may provide an overview section 110 explaining what the consumer 10 will be doing with the video camera 50. The instructional video 90 may also include an operating section 120 explaining how to use the video camera 50. For instance, the video instructions 90 may include a demonstration, where an instructor may demonstrate use of the video camera 50, by interacting with a similar model of the video camera 50, in the instructional video 90. The instructional video 90 may also include a procedures section 130 where consumers 10 are instructed as to what they should do and how they should act. For example, the instructor may emphasize to consumers 10 that they should “act natural,” and that the consumers 10 should not modify their habits or surroundings for the video camera 50. The instructor may also instruct the consumers 10 to provide insights on how or why they engaged in an activity that they captured with the video camera 50. For instance, the instructor may instruct the consumer 10 to provide an audio commentary 80 as the consumer 10 is capturing video.

Where instructions 60 are provided in a DVD instructional video 90 as in the present example and as seen in FIG. 3, the instructional video 90 may further include a sample videos section 140, which may contain a “sample video” to demonstrate to the consumer 10 how the video that the consumer 10 is to capture might look. The sample video may include one or more instructors playing the role of a consumer 10—e.g., engaging in consumer-related activities 70 and providing audio commentary 80 relating to their activities 70. One or more perspectives may be used during such portion of the instructional video 90. One perspective may be from that of a “mock camera.” The mock camera may be the same type of video camera 50 that the consumer 10 has received or will receive, and may be operated by an instructor playing the role of a consumer 10. In other words, an instructor playing the role of a consumer 10 may capture video with audio commentary 80 using a video camera 50, and the captured video/audio may be inserted into the instructional video 90. In particular, while playing the role of a consumer 10 capturing video of his/her own habits and activities 70, and while capturing video during such role playing, a role-playing instructor may provide audio commentary 80 explaining what activity 70 he/she is engaged in, why they are engaging in that activity 70, why they are engaging in the activity 70 in the particular way that they are engaging in that activity 70, reasons why they are making choices that are being captured in the video, etc.

Another perspective in a sample video section 140 of an instructional video 90, as shown in FIG. 3, may be from that of a “third party camera.” The third party camera may capture footage of the role-playing instructor playing the role of the consumer 10, including footage of the role-playing instructor using the video camera 50 as a consumer 10 would. Various other perspectives that may be used in an instructional video 90 will be apparent to those of ordinary skill in the art.

A sample video section 140 of an instructional video 90 may include scenes based on any suitable consumer activity 70. By way of example only, a sample video may be set in any number of the following contexts, among others: lunch, laundry, music downloading, snack time, etc. The foregoing elements of an instructional video 90 are intended to be merely illustrative, and are not intended to be exhaustive. Any other elements may be incorporated into an instructional video 90, and any of the elements mentioned above may be omitted or varied in any suitable way. Furthermore, while the instructional video 90 of the present example, and as shown in FIG. 3, is provided on a DVD, it will be appreciated that an instructional video 90 may be provided in any other suitable format. For instance, an instructional video 90 may be provided as streaming video on-line, as a downloadable movie file, on tape, or otherwise. It will also be appreciated that an instructional video 90 may be omitted altogether.

As also noted above, the set of instructions 60 in the present example, and as shown in FIG. 3, further comprises an instructional booklet 100. To the extent that an instructional video 90 accompanies an instructional booklet 100, the video 90 may refer to the booklet 100 one or more times, and/or the booklet 100 may refer to the video 90 one or more times. As with the instructional video 90, the instruction booklet 100 may include a variety of elements. For instance, the booklet 100 may include a general overview section 145 of what is expected of the consumer 10. The booklet 100 may also contain an operating section 150 that includes illustrated details on how to operate the video camera 50. In addition, the booklet 100 may include a procedures section 155 providing further details relating to activities 70 and commentary 80—e.g. commentary 80 that the consumer 10 is expected to provide while capturing video. The booklet 100 may also emphasize that the consumer 10 should “act natural,” and that the consumer 10 should not rearrange things in their homes or other surroundings due to the presence of the video camera 50.

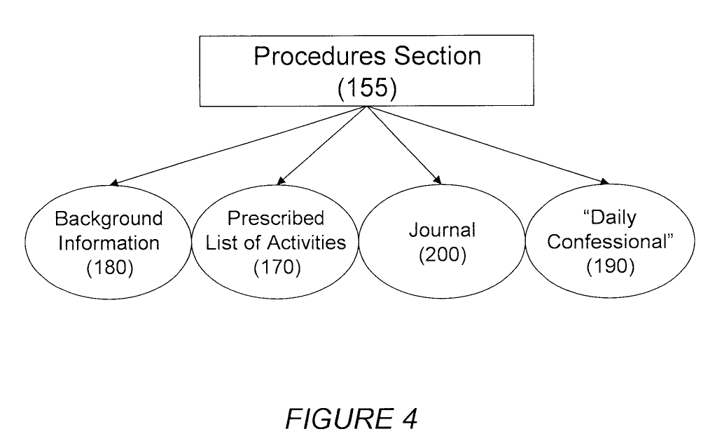

Referring to FIG. 4, an element of the instruction booklet's 100 procedures section 155 may be a prescribed list of activities 170 for the consumer 10 to capture on video. In the present example, the listed activities 170 are those that the consumer 10 would engage in, such as on a daily basis, regardless of the instructions 60 (e.g., eating lunch). Alternatively, the listed activities 170 may include some activities 70 that the consumer 10 would likely not otherwise engage in on a day-to-day basis (e.g., shopping for groceries). The prescribed list 170 may also specify particular portions or aspects of such activities 70 that should be captured on video by the consumer 10. Similarly, the list may specify particular points of commentary 80 that should be provided by the consumer 10 as the consumer 10 is engaging in the activity 70.

By way of example, the prescribed list 170 may state, “Show and tell us about at least 5 snacking and treat times that occur during the week. If you eat snacks and treats at different times during the day please try to capture these different times.” Additionally, the prescribed list 170 may state, “Using the video camera 50 show us: you deciding what to have for a snack/treat; you retrieving the snack/treat from where it is stored; you getting ready to eat the snack/treat (show us any preparation that is required before eating); you eating the snack/treat (have someone film you or put the video camera 50 down; take the video camera 50 to wherever it is you are having the snack).” In terms of commentary 80, the prescribed list 170 may request, “Please tell us: what time of day it is; why you decided you want a snack/treat; how you decided what snack/treat to have; who is with you (if anyone); how you feel after eating the snack/treat (did it fill you up, was it satisfying, did it taste good, was it fun to eat?).” In addition to requesting video and commentary 80 for a prescribed list of activities 170, the instructional booklet 100 may also request that the date and time of the activities 70 be recorded, either in written form, embedded in the video, or included in the commentary 80.

In another example, the prescribed list 170 may state, “Show us how you ask your mom to buy a certain snack or treat item. Using the video camera 50, actually film yourself asking your mom to buy something in particular from the store. We want to see and hear the conversation the two of you have. Either before or after this request, tell us whether this snack or treat is something your mom has purchased for you before. If it's a new snack or treat you want mom to buy, please tell us how you found out about it.”

In another example, the prescribed list 170 may state, “Show us and tell us about all of the snack and treat items in your pantry, fridge and freezer. Using the video camera 50, actually film the snack and treat items in your pantry, fridge and freezer. As you film, point out your favorite snacks and treats and any items that you dislike for snacks and treats. Also point out any items you have asked your mom to buy. If there are other spots in the house where you keep snacks and treats, please film there too.”

Consumer-related activities 70 may be among those listed in the instructional booklet 100 for the consumer 10 to capture video of. In other words, the booklet 100 may instruct the consumer 10 to capture video of the consumer 10 engaging in selection and/or consumption of goods or services. Other activities 70 may be listed in the booklet 100 as well. Again referring to FIG. 4, the booklet 100 may instruct the consumer 10 to capture on video, certain background information 180 of the consumer's 10 family members, home, or other aspects of the consumer's 10 life that are not necessarily directly tied to consumption of goods or services. Such activity 70 may provide biographic, demographic, and/or other information 40 that may be useful in conjunction with information 40 relating to the consumer's 10 consuming habits. As an example an instructional booklet 100 may request a “background”-type of activity 70 by stating, “Show us and tell us about your family and your life. Using the video camera 50: actually film and tell us about your family; show us your bedroom; show us your favorite spot(s) in the house (to hang out, play, etc.); show and tell us about your hobbies and what you like to do.” In addition to requesting video and commentary 80 for background information 180, the instructional booklet 100 may also request that the date and time of the activities 70 be recorded, either in written form, embedded in the video, or included in the commentary 80.

While embodiments described above include the consumer 10 providing commentary 80 relating to habits/activities 70 as the consumer 10 is engaging in such habits/activities 70, it will also be appreciated that the consumer 10 may be instructed to provide commentary 80 relating to habits/activities 70 at some time other than that at which the consumer 10 is engaging in such habits/activities 70. For instance, referring to FIG. 4, an instruction booklet 100, instruction video 90, or other medium may include an instruction for the consumer 10 to provide a “daily confessional” 190 or similar commentary 80. Such a commentary 80 may include the consumer 10 simply capturing video of himself/herself, without engaging in consuming activities 70, providing a commentary 80. The commentary 80 may relate to activities 70 that had been previously captured on video, to activities 70 that have not been captured on video, or to any other activities 70 or information. As an example an instructional booklet 100 may request a “confessional”-type of activity 190 by stating, “At the end of three days, film yourself as you recap the snacks and treats that you remember having. Do not limit it to what you videotaped that day. Please do this at least one time on a week night and at least one time on a weekend night. Briefly tell us what you remember eating and around what time of the day it was. We want to know about your favorite snack or treat of the day. Please tell us what it was and why.” In addition to requesting video and commentary 80 for a “daily confessional” 190, the instructional booklet 100 may also request that this exercise be conducted a minimum number of times and that the date and time of the activities 70 be recorded, either in written form, embedded in the video, or included in the commentary 80.

It will be appreciated that the printed instructional booklet 100 of FIG. 3 may also be used to capture additional consumer information 40 to supplement information 40 captured on video or otherwise. For instance, the booklet 100 may include one or more surveys 160 or fact reporting sections 165 or other means to elicit information 40. Information 40 elicited through the booklet 100 may correspond with information 40 captured on video or otherwise. For instance, the booklet 100 may have questions, blanks to fill in, or the like, provided with instructions relating to a particular activity 70. As discussed previously, the consumer 10 may be asked to list the time/date corresponding to video captured of a certain activity 70. Alternatively, information elicited in the booklet 100 may have no particular or direct relationship with activities 70 captured on video by the consumer 10. By way of example, referring to FIG. 4, an instructional booklet 100 or instructional video 90 may request that a consumer 10 create a journal 200 for recording relevant information 40. An example of an instructional booklet's 100 request for a journal 200 might state, “Please record all snacks and treats that you eat over the course of the week. For each snack or treat you eat, please fill in the date, time of day, a description of what you eat, and the brand name if you know it. At the end of each day, please fill in your favorite snack/treat that you had that day.” Other types of information 40 that may be elicited through a booklet 100 will be apparent to those of ordinary skill in the art. Furthermore, just as the booklet 100 may be substituted or supplemented in any suitable way (e.g., by one or more web pages, one or more e-mails, etc.), so may methods for eliciting additional information 40 from consumers 10 (e.g., by one or more web pages, one or more e-mails, etc.). Suitable supplements and substitutes for a booklet 100, both as a means for providing instructions 60 and as a means for eliciting information 40, will be apparent to those of ordinary skill in the art.

A consumer 10 may also be asked to capture video and/or audio in a variety of environments, including but not limited to home, school, sporting events, sponsored events, retail establishments, work, etc. Of course, a consumer 10 may also capture video in such environments incidentally. It will also be appreciated that, in some environments, a consumer 10 may capture video that includes third parties within the field of view of the video camera 50 or within the video image frame; or audio including utterances of third parties. To the extent it is necessary (e.g., under applicable law, under agreement, under a standard policy, etc.), or to the extent it is otherwise desirable to do so, the presence of such third parties may be dealt with in a number of ways. For instance, if the captured video is to be presented to a provider of goods or services 30, or to another entity, and if third parties captured in the video have not consented to the capture and/or presentation of the portions of the video depicting them, the faces of such third parties may be obscured in the video using suitable processing. Confidentiality of third parties and their identities may otherwise be protected in any suitable fashion. Similar issues of consent and/or confidentiality may arise where the consumer 10 is a minor. Nevertheless, in some situations, insights may be obtained through the presence, utterances, behavior, etc., of third parties captured in video or audio. Such insights may supplement or otherwise inform insights regarding the consumer 10 capturing the video/audio.

While the instructions 60 noted above, and as seen in FIGS. 2 and 3, relate to the consumer 10 capturing video and providing commentary 80, the instructions 60 may also relate to activities 70 for the consumer 10 to engage in after the video and commentary 80 have been captured. For instance, the instructions 60 may relate to the consumer's 10 submission of the video and commentary 80 to a particular person or entity for review, follow-up interviews by a particular person or entity, or other activities 70. Still other suitable elements of instructions 60, in any form, will be apparent to those of ordinary skill in the art.

While the foregoing examples include the submission of video and information 40 in a booklet 100, by the consumer 10, after the video has been captured and after the booklet 100 has been completed, it will be appreciated that any of the same may be submitted in real time or near real time. For instance, a video camera 50 (e.g., a web cam) may be provided in communication with a network, such as the Internet, such that video captured by the video camera 50, and/or commentary 80 provided by the consumer 10, may be communicated over the network to a remote location in real time or near real time. Similarly, a research group 20 or other person or entity may provide instructions 60 to the consumer 10 while the consumer 10 is engaging in a study (e.g., during a period where the consumer 10 has the video camera 50 and is capturing video of his/her activities 70 from time to time). For instance, an initial set of instructions 60 may be provided to the consumer 10 at the beginning of a study, with additional instructions 60 being provided periodically as the consumer 10 has the video camera 50. Alternatively, additional instructions 60 may be provided to the consumer 10 “on-the-fly” or on some other non-periodic basis. In either case, additional instructions 60 may be established, at least in part, before the study begins; and/or they may be tailored, at least in part, based on information 40 or video submitted by the consumer 10.

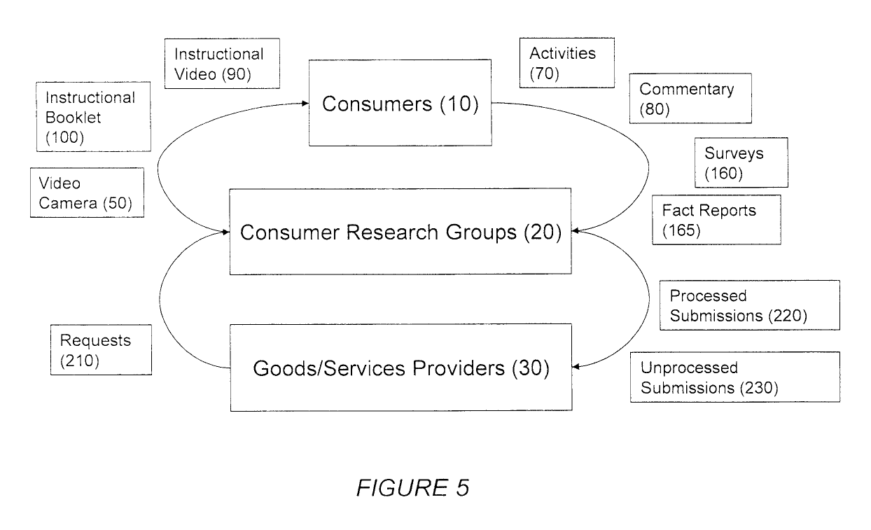

One exemplary implementation of the embodiments described herein, as shown in FIG. 5, may be for a consumer research study. For instance, a provider of goods or services 30 may make a request 210 for a study by a consumer research group 20 (or by other persons or entities). The request 210 may be provided in terms of a particular demographic, geographic location, good/service to be studied, or in other terms. The consumer research group 20 may then select one or more consumers 10 to engage in the study based on any suitable criteria. The consumer research group 20 may then send a video camera 50, instructional video 90, instructional booklet 100, and/or other media to the selected consumers 10 in accordance with the request 210. The materials sent to the consumers 10 may be tailored, at least in part, specifically for the request 210 by the goods/service provider 30, or may be selected from an existing set of materials based on the request 210 or on other criteria. The consumers 10 may capture video of activities 70 and provide commentary 80 and/or other information 40 in accordance with the instructions 60, then submit the video, completed booklet 100, etc., to the consumer research group 20. The consumer research group 20 may process the submissions 220 by the consumers 10 in any suitable fashion. For instance, the consumer research group 20 may generate a report to provide to the requesting goods/services provider 30 based on the consumer submissions 220, 230. The consumer research group 20 may additionally or alternatively pass at least a portion of unprocessed submissions 230 from the consumers 10 on to the requesting goods/services provider 30. It will also be appreciated that the consumer research group 20 may conduct a follow up study based on consumer submissions 220, 230, including but not limited to interviews or focus groups employing the submitting consumers 10. Alternatively, consumer submissions 220, 230 may be processed in any other suitable way.

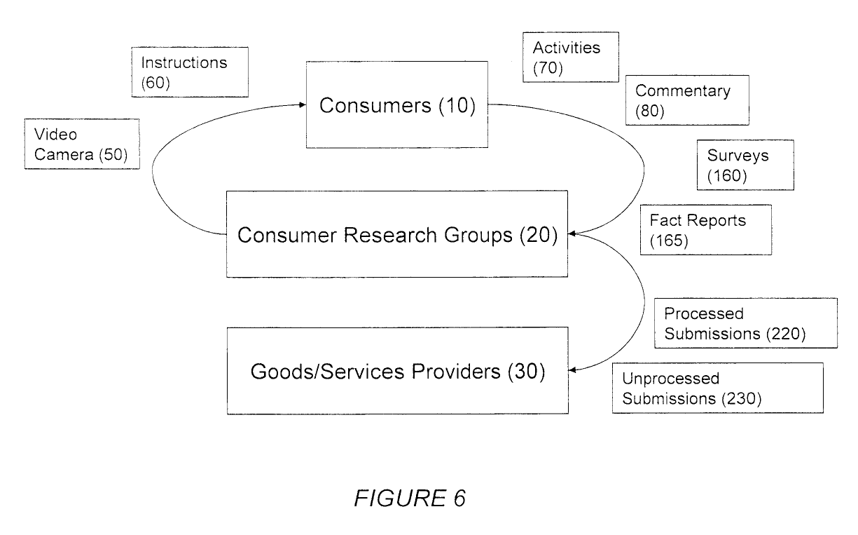

As shown in FIG. 6, it will also be appreciated that studies may be conducted in accordance with examples provided herein without any particular request 210 from a goods/services provider 30 having been made. For instance, a consumer research group 20 (or other person or entity) may devise one or more sets of instructions 60 based on their own criteria or parameters in order to obtain consumer information 40. Such instructions 60 may be sent to various groups of consumers 10, along with video cameras 50 or other devices, to gather various types of consumer information 40. The results of such studies may be processed by the consumer research group 20 in any suitable way for any suitable purpose. For instance, the consumer research group 20 may generate statistical data relating to consumer behavior. The data may be compiled into reports based on any suitable criteria. Such statistical reports may be provided to goods/services providers 30 or other entities upon request 210 by the goods/services providers 30, and may be tailored to a request 210, without necessarily involving the need to gather additional data from consumers 10. Still other ways in which consumer information 40 may be used, obtained, and provided, including conditions under which such information 40 may be used, obtained, and provided, will be apparent to those of ordinary skill in the art.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of whatever claims recite the invention, and is understood not to be limited to the details of structure and operation shown and described in the description.

What is claimed is:

1. A method for obtaining consumer information, comprising the steps of:
(a) sending a video camera to one or more consumers,
(b) providing instructions to the one or more consumers on how to use the video camera,
(c) receiving recorded submissions from the consumers, wherein the submissions comprise recordations made during the act of recording, and
(d) analyzing the submissions.

2. The method of claim 1, wherein the instructions further comprise an operating section instructing the one or more consumers on how to operate the video camera.

3. The method of claim 1, wherein the instructions further comprise an overview section instructing the one or more consumers on what to do with the video camera and how activities should be recorded with the video camera.

4. The method of claim 1, wherein the instructions further comprise a procedures section instructing the one or more consumers on activities and commentary to record with the video camera.

5. The method of claim 4, wherein the procedures section further comprises a background information activity, the method further comprising instructing the one or more consumers to record their surroundings while commenting about the surroundings.

6. The method of claim 4, wherein the procedures section further comprises a journal activity, the method further comprising instructing the one or more consumers to record their consumer habits in a written form.

7. The method of claim 4, wherein the procedures section further comprises a confessional activity, the method further comprising instructing the one or more consumers to record themselves while recalling their consumer habits.

8. The method of claim 4, wherein the procedures section further comprises a prescribed list of activities, the method further comprising instructing the one or more consumers to record the activities and provide associated commentary.

9. The method of claim 1, wherein the instructions further comprise an instructional video portion and an instructional booklet, the method further comprising sending the instructional video portion and the instructional booklet to the one or more consumers.

10. The method of claim 9, wherein the instructional booklet further comprises surveys, the method further comprising instructing the one or more consumers to complete the surveys.

11. The method of claim 9, wherein the instructional booklet further comprises fact reporting sections, the method further comprising instructing the one or more consumers to complete the fact reporting sections.

12. The method of claim 9, wherein the instructional video further comprises a sample video section, the method further comprising instructing the one or more consumers to use the video camera in a manner shown in the sample video section.

13. The method of claim 12, wherein the sample video section further comprises a video camera operating sample video, the method further comprising instructing the one or more consumers on operating the video camera.

14. The method of claim 12, wherein the sample video section further comprises a consumer perspective sample video, the method further comprising instructing the one or more consumers on how to record consumer activities.

15. The method of claim 12, wherein the sample video section further comprises a third-party perspective sample video, the method further comprising instructing the one or more consumers on how to record consumer activities.

16. The method of claim 1, wherein the video camera further comprises a still image camera feature, the method further comprising instructing the one or more consumers to record still images.

17. The method of claim 1, wherein the video camera further comprises an audio recorder, the method further comprising instructing the one or more consumers to record audio commentary.

18. The method of claim 17, wherein the method further comprises instructing the one or more consumers to record the audio commentary contemporaneously with the recorded activities.

19. A method for obtaining consumer information, comprising the steps of:
(a) receiving a video camera and instructions from a consumer research group,
(b) reviewing the instructions from the consumer research group,
(c) recording activities and commentary using the video camera in accordance with the instructions, and
(d) submitting recorded submissions to the consumer research group, wherein the submissions comprise recordations made during the act of recording.

20. A system for obtaining consumer information, comprising:
(a) a video camera,
(b) a set of instructions, wherein the instructions relate to how to operate the video camera and activities to be recorded using the video camera,
(c) a video recording, wherein the video recording is captured in accordance with the instructions, and
(d) a narration, wherein the narration is associated with the video recording, wherein the narration is provided in accordance with the instructions.
